(19) United States
(12) Patent Application Publication
(10) Pub. No.: US 2014/0185305 A1
(43) Pub. Date: Jul. 3, 2014

(54) LIGHTING DEVICE

(71) Applicant: Yasuhiro Takahashi, Kawasaki-shi (JP)

(72) Inventor: Yasuhiro Takahashi, Kawasaki-shi (JP)

(73) Assignee: Pioneer Corporation, Kawasaki-shi (JP)

(21) Appl. No.: 14/116,119

(22) PCT Filed: May 11, 2011
(86) PCT No.: PCT/JP2011/060874

§ 371 Date: Feb. 3, 2014

(51) Int. Cl. F21V 29/00

(52) U.S. Cl. CPC F21V 29/004
USPC 362/373; 362/362

(57) ABSTRACT

A lighting device includes a face light emitter and a housing having an internal cavity. The internal cavity is defined by a wall and the face light emitter. The face light emitter is an electroluminescence panel having a permeable substrate to planarly radiate visible light. The electroluminescence panel has a plurality of holes each communicating from the internal cavity to an outside space.

### TECHNICAL FIELD

The present invention relates to lighting devices using an electroluminescence panel.

### BACKGROUND ART

In recent years, an organic electroluminescence device (abbreviated as an organic EL device hereinafter) having a plurality of organic material layers using organic materials having charge-transporting properties (e.g., mobilities of hole and/or electron) is paid attention to the electroluminescence panel since it has a higher luminance and higher emission efficiency than that of an inorganic electroluminescence device (abbreviated as an inorganic EL device hereinafter). The organic EL devices are rapidly practiced as flexible thin surface light sources in industries of mobile phone, car navigation systems and TV displays. Further the organic EL devices are adapted to applications of special illuminations such as endoscope etc. Further the applications of LED of point light sources for the lighting device also have been increased. The applications of these light sources of the special illuminations are as follows. For example, there is an air-conditioning inlet or outlet integration type LED lighting system, which is structured such a manner that a long and thin lighting device comprising an LED light emitter is fixed on a frame body of an air-conditioning inlet or outlet, and it is formed to have an oblong air-conditioning inlet or outlet device as a whole. (See a Patent Literature 1.) In addition, there is a dentistry and medicine equipment comprising a hand piece head section, and surface light sources of an EL element provided in the hand piece so as to surround an opening for attachment and detachment of a tool for medical examination (air pipe or water pipe). (See a Patent Literature 2.) There is an endoscope distal end tip comprising an illumination means of organic EL elements, a light receiving part, and a through hole for insertion of a treatment instrument, which are formed so that the illumination means detours the through hole (the illumination means and the through hole having openings). (See a Patent Literature 3.) There is a surface light device used for a ceramic filter comprising a face light emitter radiating ultraviolet rays or the like, and a porous body layer the surface of which a plurality of pores are formed to be flow paths of vertical fluids respectively. (See a Patent Literature 4.)
Patent Literature 1: Japanese Unexamined Patent Publication No. 2008-117678
Patent Literature 2: Japanese Unexamined Patent Publication No. 2010-227157
Patent Literature 3: Japanese Unexamined Patent Publication No. 2010-46282
Patent Literature 4: International publication WO 2005/123246

### DISCLOSURE OF THE INVENTION

### Problem to be Solved by the Invention

In conventional electronics industry, precision machinery industry, precision print industry or the like, a clean room for removing dusts has been used for the purpose of promoting the quality improvement of usable precision products and improving the manufacturing yield thereof. In case that fluorescent lamps are used as illumination in the clean room, the fluorescent lamps are covered with yellow tubes on the outer glass surfaces thereof to absorb light of wavelength 500 nm or less and ultraviolet rays in general. Thus the interior of the clean room is illuminated with yellow light.

In addition, lighting devices and blowing devices are individually provided in the clean room in general. Thus unification of these devices may be expected for effective utilization of space such as the ceiling periphery in the clean room. To cover the lighting device with the yellow tube to be used in the clean room restricts a part of emitted light to lower the efficiency for light utilization. In addition, the conventional fluorescent lamps, electric light bulbs or the like have a low cooling efficiency at the emission surface thereof because any ventilating holes are not provided on the emission surface. Thus the lighting part and blowing part have to be separately provided to occupy a large amount of space in the clean room.

However, it is not considered to improve the cooling efficiency of the device or the like under the condition ultraviolet rays are not used in the lighting technologies described in Patent Literatures 1-4 in order to effectively utilize the space within the device.

Accordingly, there is one of exemplary tasks to be achieved by the present invention to provide a compact lighting device capable of keeping a cooling efficiency of the emission part thereof.

### Means for Solving the Problem

A lighting device according to the present invention comprising:

a face light emitter; and

a housing having an internal cavity, the internal cavity defined by a wall and the face light emitter;

wherein the face light emitter is an electroluminescence panel having a permeable substrate to planarly radiate visible light,

wherein the electroluminescence panel has a plurality of holes each communicating from the internal cavity to an outside space.

### BRIEF DESCRIPTION OF THE DRAWINGS

FIG. 1 is a schematic perspective view partially cut showing a lighting device having ventilating holes of an illumination panel according to an embodiment of the present invention.

FIG. 2 is a schematic partial plan view showing a portion of an organic EL panel according to another embodiment of the present invention.

FIG. 3 is a cross section view cut along an A-A line in FIG. 2.

FIG. 4 is a cross section view cut along a B-B line in FIG. 2.

FIG. 5 is a schematic partial cross view showing a portion of an organic EL device used in the embodiment of the present invention.

FIG. 6 is a schematic perspective view partially cut showing an illumination panel having ventilating holes of the lighting device according to another embodiment of the present invention.

FIG. 7 is a schematic perspective view partially cut showing another illumination panel having ventilating holes of the lighting device according to another embodiment of the present invention.

FIG. 8 is a plan view showing another lighting device according to another embodiment of the present invention.

FIG. 9 is a cross section view cut along an A-A line in FIG. 8.

FIG. 10 is a schematic partial plan view showing another organic EL panel according to another embodiment of the present invention.

FIG. 11 is a cross section view showing an inorganic EL panel according to another embodiment of the present invention.

### DETAILED DESCRIPTION OF THE INVENTION

The embodiments according to the present invention will be described herein below with reference to the drawings.

[Lighting Device]

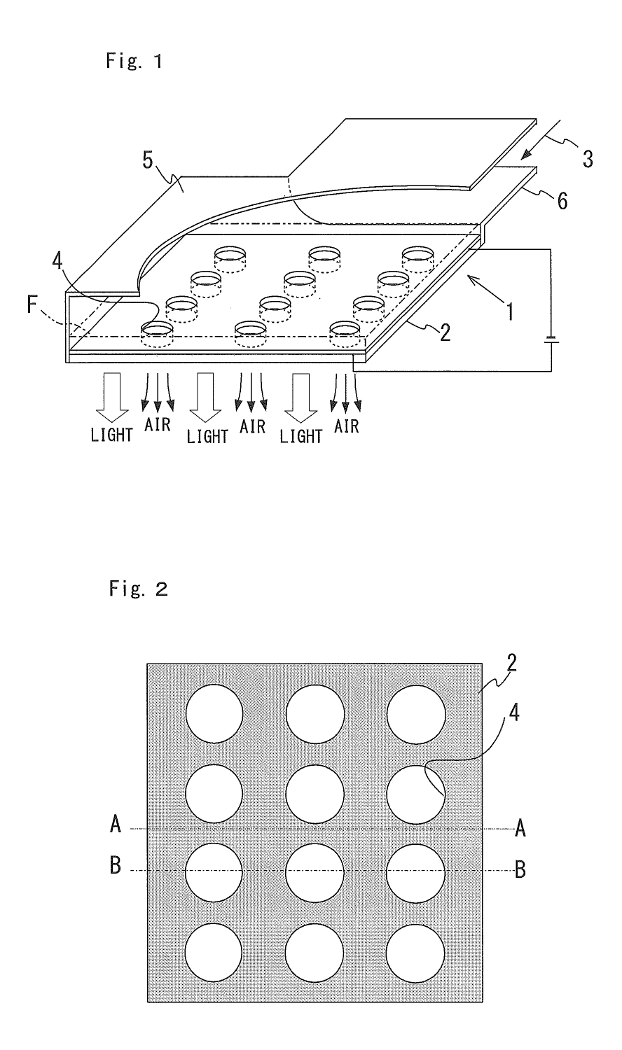

FIG. 1 shows a lighting device of the embodiment having ventilating holes having an illumination panel device 1 using an organic EL panel as an electroluminescence panel. A sheet shaped organic EL panel 2 is used as a main body of the illumination panel of a face light emitter. The organic EL panel 2 has a plurality of holes 4 formed on the surface thereof each communicating from the internal cavity to an outside space. The illumination panel device 1 with ventilating holes includes a wall of housing including the organic EL panel 2 so as to define the internal cavity in the housing 5. A external blower (not shown) provides air 3 through a conduit 6 to the housing 5 to eject the air through the holes 4. The outer surface of the organic EL panel 2 other than the holes 4 performs an illumination function. As shown in FIG. 1, an air filter F against dust such as HEPA (high efficiency particulate air) filter, ULPA (ultra low penetration air) filter or the like may be arranged to confront the holes 4 in parallel within the internal cavity of the housing 5.

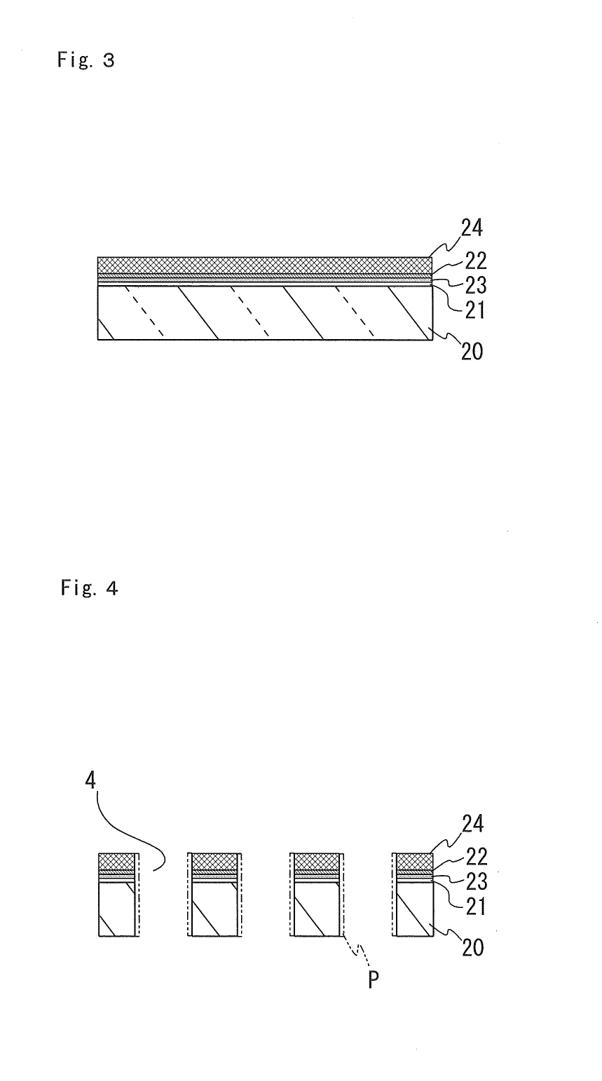

FIG. 2 illustrates a schematic partial plan view showing a portion of an organic EL panel according to another embodiment of the present invention. FIG. 3 illustrates a cross section view cut along an A-A line in FIG. 2, and FIG. 4 illustrates a cross section view cut along a B-B line in FIG. 2.

As shown in FIG. 3 and FIG. 4, the face light emitter of organic EL panel 2 comprises a permeable substrate 20; a first electrode 21 with transparency; a second electrode 22 with light-reflectivity; and a plurality of the organic material layers 23 which are layered and disposed between the first electrode 21 and the second electrode 22 and include a light-emitting layer with at least one luminescent color. The substrate 20 supports the first electrode 21 and emits visible light planarly from the side of the substrate 20. Thus, the embodiment of the present invention is the lighting device comprising the organic EL panel 2 and the housing 5 having a wall including the organic EL panel defining the internal cavity. The organic EL panel 2 comprises a protective layer 24 which is provided onto the second electrode 22 in a layered. As shown in FIG. 4, the organic EL panel 2 comprises protective films P so that all of inner wall surfaces of the holes of the organic EL panel are protected with the protective films such as moisture-proof barrier film or the like.

Since the openings of the plurality of holes 4 are provided on the planer organic EL panel 2 and used for ventilation ports, if the present embodiment is used for a clean room, then use of the yellow filter is not need. Therefore the present embodiment can simplify the structure of the illuminating device. Since illumination and ventilation are carried out by the same device of the present embodiment, there is obtained an excellent efficiency for space utilization in the clean room. The present embodiment can prolong the emission life of the illuminating device, since the temperature of the organic EL panel 2 is lowered by the ventilation.

[Organic EL Panel]

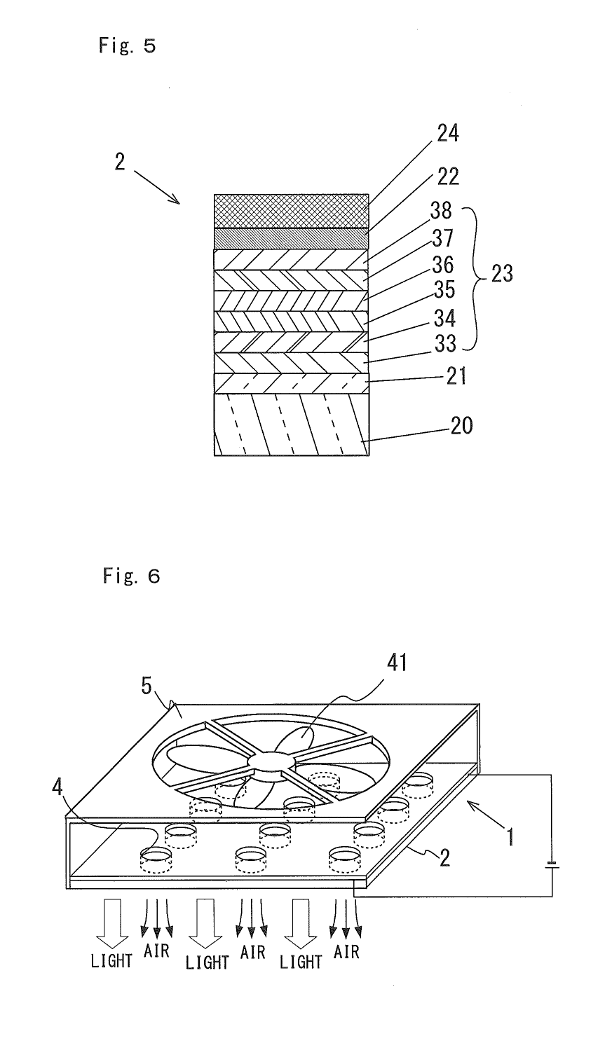

An example of the organic EL panel 2 according to the embodiment will be described in detail hereinafter. As shown in FIG. 5, the EL panel 2 is formed such that the transparent anode 21 (the first electrode), the hole injection layer 33, the hole transport layer 34, the light-emitting layer 35, the hole-blocking layer 36, the electron transport layer 37, the electron injection layer 38 and the cathode 22 (the second electrode) made of metal are layered in order on the transparent substrate 20 made of glass or the like. The hole injection layer 33, the hole transport layer 34, the light-emitting layer 35, the hole-blocking layer 36 and the electron transport layer 37 belong to the organic material layer 23. That is, a plurality of the organic material layer layered and disposed between a pair of the anode and the cathode facing each other in the organic EL device include the hole injection layer, the hole transport layer, the light-emitting layer, the hole-blocking layer, the electron transport layer and the electron injection layer. These components of the organic material layer or the like are described later. Thus each organic EL element of the organic EL panel is an organic EL device comprising a plurality of the organic material layer which include the light-emitting layer and layered and disposed between a pair of the anode and the cathode facing each other. Further, any organic material layer of the light-emitting layer, the hole injection layer, the hole transport layer or the like may be formed as a thin film through a vacuum evaporation method or the like, a dry film-forming method, an ink-jet printing method or the like, or a set film-forming method.

Further, if a slash “/” denotes an interface between adjacent layers contacting one another shown in FIG. 5, then the layered structure of the organic EL panel is described as the anode 21/hole injection layer 33/hole transport layer 34/light-emitting layer 35/hole-blocking layer 36/electron transport layer 37/electron injection layer 38/cathode 22. In addition to this structure, there are some layered structures such as the anode 21/hole injection layer 33/light-emitting layer 35/electron transport layer 37/electron injection layer 38/cathode 22 in which the hole transport layer 34 and the hole-blocking layer 36 are omitted, and the anode 21/hole transport layer 34/light-emitting layer 35/electron transport layer 37/electron injection layer 38/cathode 22 in which the hole injection layer 33 and the hole-blocking layer 36 are omitted, and the anode 21/light-emitting layer 35/electron transport layer 37/electron injection layer 38/cathode 22 in which the hole injection layer 33, the hole transport layer 34 and the hole-blocking layer 36 are omitted, which these structures are included in the invention, but not shown as figures. Further the layered structure of the organic EL panel may be constructed in a reverse order of described layers excepting the substrate in the invention. Anyway the present invention is not limited to the described layered structures, and the present invention include a layered structure of at least one light-emitting layer as well as a layered structure that the light-emitting layer is used as a carrier transport layer.

[Substrate]

A plate of quartz or glass, or a metal plate, or a metal foil, or a flexible substrate of resins, a plastic sheet, a plastic film or the like is used for the substrate 20. It is preferable to use a plate of glass or transparent synthetic resin such as polyester, polymethacrylate, polycarbonate, polysulfone or the like for the substrate. In case that a synthetic resin is used for the substrate, it is necessary to note the gas-barrier property of the synthetic resin. If the gas-barrier property of the substrate is too low, then outside air passing through the substrate deteriorates the organic EL device. Thus, it should be avoided. For this reason, there is one of the preferred methods to form a dense silicon oxide film or the like on at least one side the substrate of synthetic resins in order to ensure the gas-barrier property.

[Anode and Cathode]

Normally, a metal such as aluminum, gold, silver, nickel, palladium, platinum or the like is used for the anode 21 supplying holes toward the light-emitting layer. The anode may be composed of a metal oxide such as tin oxide and/or indium and zinc oxide (ITO or IZO) or the like, or a metal halide such as copper iodide, or carbon black, or a conductive polymer such as poly(3-methylthiophene), polypyrrole, polyaniline or the like.

Formation of the anode is normally performed by a sputtering method, a vacuum deposition method or the like mostly. In addition, metal particles such as silver or the like, particles such as copper iodide or the like, carbon black, conductive metal oxide particles, conductive polymer particles or the like may be used to the anode. In this case, the particles are dispersed in a suitable binder resin solution and then the solution is applied onto the substrate, so that the anode is formed. In addition, since a conductive polymer may be formed through an electro-polymerization, by using this a conductive thin polymer film may be directly formed on the substrate as an anode.

The anode normally has a single layer structure. The anode may have a multiple layered layer structure made from a plurality of materials if desired.

The thicknesses of the anode are various according to transparency that is required. Permeability of the anode in visible light is normally 60% or more, preferably 80% or more if required. In this case, the thickness of the anode ranging from normally 5 nm or more, preferably 10 nm or more to normally 1000 nm or less, preferably 500 nm or less. If an opaque anode is required, the anode has an optional thickness and then the anode may be unified with the substrate 20. In addition, the anode may be layered with different conductive materials.

In order to improve the hole injection property of the anode by removing impurities adhered on the anode and adjusting the ionization potential thereof, the surface of the anode is preferably surface-treated by Ultraviolet ray (UV) treatment or Ozone treatment, Oxygen plasma treatment or Argon plasma treatment preferably.

With respect to materials for the cathode 22 supplying electrons toward the light-emitting layer, materials of the anode can be used for the cathode 22. Metals with a low work-function such as tin, magnesium, indium, calcium, aluminum, silver or the like or alloy thereof may be used for cathode materials to obtain electron-injection with a good efficiency. It is preferable to use, for the anode 21, a selected conductive material having a high work function higher than that of the cathode 22. As a specific example, there is magnesium-silver alloy, magnesium-indium alloy, aluminum-lithium alloy or the like for a work-function alloy electrode.

Further, only one material may be used for the cathode 22, or optional combination of two or more materials with a ratio thereof may be used for the cathode. The thickness of cathode may be normally the same as the anode.

In addition, for the purpose of protecting the cathode made of a low work-function metal, a further metal layer having a high work-function and stability against the air may be preferably layered on the cathode because of improved stability of the device. For this purpose, metals such as aluminum, silver, copper, nickel, chrome, gold, platinum or the like may be used, for example. Further, from these materials, only one material may be used for the further metal layer, or optional combination of two or more materials with a ratio thereof may be used for the further metal layer.

Furthermore, if at least one of the anode and cathode is arranged at the side from which light emission is take out, then materials and thicknesses of the anode and cathode are selected and set so that the least one of the anode and cathode is transparent or semi-transparent. Specifically one or both of the anode and cathode is preferably made of a material having a transmissivity of at least 10% or more in the wavelength of light emitted from the light-emitting material layer. These electrodes may be formed by a patterning process if necessary.

[Organic Material Layer]

With regard to the materials as main components of the organic material layers including the hole injection layer 33, the hole transport layer 34, the light-emitting layer 35, the electron transport layer 37 and the electron injection layer 38, there are utilized organic compounds having the charge-transporting property (e.g., mobility of hole and/or electron).

As for phosphorescent organic compounds used for the light-emitting layer 35, Iridium complex such as Bis(3,5-difluoro-2-(2-pyridyl)phenyl-(2-carboxypyridyl)iridium III, Tris(2-phenylpyridine)iridium(III), Bis(2-phenylbenzothiazolato)(acetylacetonate)iridium(III), or Osmium complex such as Osmium(II)bis(3-trifluoromethyl-5-(2-pyridyl)-pyrazolate)dimethylphenylphosphine, or rare-earth element compounds such as Tris(dibenzoylmethane)phenanthroline europium(III), or Platinum complex such as 2,3,7,8,12,13,17,18-Octaethyl-21H, 23H-porphine platinum(II) etc. can be used. The light-emitting layer 35 is formed to have an emission layer with at least one luminescent color, or mixed luminescent color, or to have multiple emission layers with a plurality of luminescent colors.

With regard to organic compounds capable of transporting electrons each a main component of the light-emitting layer or the electron transport layer or the electron injection layer, such as polycyclic compounds such as p-terphenyl, quaterphenyl, etc. as well as derivatives thereof, condensed polycyclic hydrocarbon compounds such as naphthalene, tetracene, pyrene, coronene, chrysene, anthracene, diphenylanthracene, naphthacene, phenanthrene, etc. as well as derivatives thereof, or condensed heterocyclic compounds such as phenanthroline, bathophenanthroline, phenanthridine, acridine, quinoline, quinoxaline, phenazine, etc. as well as derivatives thereof, and fluoroceine, perylene, phthaloperylene, naphthaloperylene, perynone, phthaloperynone, naphthaloperylene, diphenylbutadiene, tetraphenylbutadiene, oxadiazole, aldazine, bisbenzoxazoline, bisstyryl, pyrazine, cyclopentadiene, oxine, aminoquinoline, imine, diphenylethylene, vinylanthracene, diaminocarbazole, pyrane, thiopyrane, polymethine, merocyanine, quinacridone, rubrene, etc. as well as derivatives thereof can be used.

In addition, other organic compounds capable of transporting electrons, such as metal-chelated complex compounds, suitable metal-chelated oxanoide compounds are metal complexes which contain, as a ligand thereof, at least one selected from 8-quinolinolato and derivatives thereof such as tris(8-quinolinolato)aluminum, bis(8-quinolinolato)magnesium, bis[benzo(f)-8-quinolinolato]zinc, bis(2-methyl-8-quinolinolato)aluminum, tri(8-quinolino lato)indium, tris(5-methyl-8-quinolinolato)aluminum, 8-quinolinolato lithium, tris(5-chloro-8-quinolinolato)gallium, bis(5-chloro-8-quinolinolato)calcium or the like can be used.

In addition, other organic compounds capable of transporting electrons, such as oxadiazoles, triazines, stilbene derivatives and distyrylarylene derivatives, styryl derivatives, diolefin derivatives can be used preferably.

Furthermore, other organic compounds capable of transporting electrons, such as the group of benzoxazoles such as 2,5-bis(5,7-di-t-pentyl-2-benzoxazolyl)-1,3,4-thiazole, 4,4′-bis(5,7-t-pentyl-2-benzoxazolyl) stilbene, 4,4′-bis[5,7-di(2-methyl-2-butyl)-2-benzoxazolyl]stilbene, 2,5-bis(5,7-di-t-pentyl-2-benzoxazolyl)thiophene, 2,5-bis[5-(α,α-dimethylbenzyl)-2-benzoxazolyl]thiophene, 2,5-bis[5,7-di(2-methyl-2-butyl)-2-benzoxazolyl]-3,4-diphenylthiophene, 2,5-bis(5-methyl-2-benzoxazolyl)thiophene, 4,4′-bis(2-benzoxazolyl)biphenyl, 5-methyl-2-{2-[4-(5-methyl-2-benzoxazolyl)phenyl]vinyl}benzoxazole, 2-[2-(4-chlorophenyl)vinyl]naphtho(1,2-d)oxazole, etc.; and the group of benzothiazoles such as 2,2′-(p-phenylenedipynylene)-bisbenzo thiazole, etc.; and the group of benzoimidazoles such as 2-{2-[4-(2-benzoimidazolyl)phenyl]vinyl}benzoimidazole, 2-[2-(4-carboxyphenyl)vinyl]benzoimidazole, etc. can be used.

Furthermore, other organic compounds capable of transporting electrons, such as 1,4-bis(2-methylstyryl)benzene, 1,4-bis(3-methylstyryl)benzene, 1,4-bis(4-methylstyryl)benzene, distyrylbenzene, 1,4-bis(2-ethylstyryl)benzene, 1,4-bis(3-ethylstyryl)benzene, 1,4-bis(2-methylstyryl)-2-methylbenzene, 1,4-bis(2-methylstyryl)-2-ethylbenzene or the like can be used.

In addition, other organic compounds capable of transporting electrons, such as 2,5-bis(4-methylstyryl) pyrazine, 2,5-bis(4-ethylstyryl)pyrazine, 2,5-bis[2-(1-naphthyl)vinyl]pyrazine, 2,5-bis(4-methoxystyryl)pyrazine, 2,5-bis[2-(4-biphenyl)vinyl]pyrazine, 2,5-bis[2-(1-pyrenyl)vinyl]pyrazine or the like can be used.

Furthermore, other organic compounds capable of transporting electrons, such as 1,4-phenylene-dimethylidine, 4,4′-phenylenedimethylidine, 2,5-xylylene-dimethylidine, 2,6-naphthylenedimethylidine, 1,4-biphenylene-dimethylidine, 1,4-p-terephenylenedimethylidine, 9,10-anthracenediyldimethylidine, 4,4′-(2,2-di-t-butylphenylvinyl)biphenyl, 4,4′-(2,2-diphenylvinyl)biphenyl or the like can be used. In addition to these organic compounds, any of the well-known compounds conventionally used in the production of the prior art organic EL devices may be suitably used.

Whereas, organic compounds capable of transporting holes, such as N,N,N′,N′-tetraphenyl-4,4′-diaminophenyl, N,N′-diphenyl-N,N′-di(3-methylphenyl)-4,4′-diaminobiphenyl, 2,2-bis(4-di-p-tolylaminophenyl)propane, N,N,N′,N′-tetra-p-tolyl-4,4′-diaminobiphenyl, bis(4-di-p-tolylaminophenyl)phenylmethane, N,N′-diphenyl-N,N′-di(4-methoxyphenyl)-4,4′-diaminobiphenyl, N,N,N′,N′-tetraphenyl-4,4′-diaminodiphenylether, 4,4′-bis(diphenylamino)quadriphenyl, 4-N,N-diphenylamino-(2-diphenylvinyl)benzene, 3-methoxy-4′-N,N-diphenylaminostilbenzene, N-phenylcarbazole, 1,1-bis(4-di-p-triaminophenyl)cyclohexane, 1,1-bis(4-di-p-triaminophenyl)-4-phenylcyclohexane, bis(4-dimethylamino-2-methylphenyl)phenylmethane, N,N,N-tri(p-tolyl)amine, 4-(di-p-tolylamino)-4′-[4-(di-p-tolylamino)styryl]stilbene, N,N,N′,N′-tetraphenyl-4,4′-diaminobiphenyl N-phenylcarbazole, 4,4′-bis[N-(1-naphthyl)-N-phenylamino]biphenyl, 4,4″-bis[N-(1-naphthyl)-N-phenylamino]p-terphenyl, 4,4′-bis[N-(2-naphthyl)-N-phenylamino]biphenyl, 4,4′-bis[N-(3-acenaphthenyl)-N-phenylamino]naphthalene, 4,4′-bis[N-(9-anthryl)-N-phenylamino]biphenyl, 4,4″-bis[N-(1-anthryl)-N-phenylamino]p-terphenyl, 4,4′-bis[N-(2-phenanthryl)-N-phenylamino]biphenyl, 4,4′-bis[N-(8-fluoranthenyl)-N-phenylamino]biphenyl, 4,4′-bis[N-(2-pyrenyl)-N-phenylamino]biphenyl, 4,4′-bis[N-(2-perylenyl)-N-phenylamino]biphenyl, 4,4′-bis[N-(1-coronenyl)-N-phenylamino]biphenyl, 2,6-bis(di-p-tolylamino)naphthalene, 2,6-bis[di-(1-naphthyl)amino]naphthalene, 2,6-bis[N-(1-naphthyl)-N-(2-naphthyl)amino]naphthalene, 4,4″-bis[N,N-di(2-naphthyl)amino]terphenyl, 4,4′-bis {N-phenyl-N-[4-(1-naphthyl)phenyl]amino}biphenyl, 4,4′-bis[N-phenyl-N-(2-pyrenyl)amino]biphenyl, 2,6-bis[N,N-di(2-naphthyl)amino]fluorene, 4,4″-bis(N,N-di-p-tolylamino) terphenyl, bis(N-1-naphthyl) (N-2-naphthyl)amine or the like can be used.

Further, in the case of formation of the hole injection layer, the hole transport layer and the hole-transporting luminescent layer, a dispersion of the above-described organic compounds in a polymer or a polymerized product of such organic compounds may be used. Moreover, so-called “π-conjugate polymers” such as polyparaphenylene vinylene and its derivatives, hole-transporting non-conjugate polymers, one typical example of which is poly(N-vinylcarbazole), and σ-conjugate polymers of polysilanes may be used for the same purpose.

For the material of the hole injection layer, which is not restricted to a specific one, metal phthalocyanines such as copper phthalocyanine (CuPc), a Copper complex, etc. as well as non-metal phthalocyanines, and electrically conducting polymers such as carbon films, polyanilines, etc. may be suitably used in the formation thereof.

[Illumination Panel with a Fan]

FIG. 6 illustrates a schematic perspective view partially cut showing an illumination panel having ventilating holes of the lighting device according to another embodiment of the present invention. The illumination panel device 1 comprises the housing 5 of the wall including the organic EL panel 2, and a fan 41 facing the organic EL panel 2 and provided onto the housing 5. The organic EL panel 2 has a plurality of holes 4 provided on the surface thereof each communicating from the internal cavity to an outside space, similarly to the foregoing embodiments.

Unification of the fan 41 and the organic EL panel 2 with holes 4 can sufficiently utilize the function of the holes 4.

[Illumination Panel Having Holes Integrated with a Control Board]

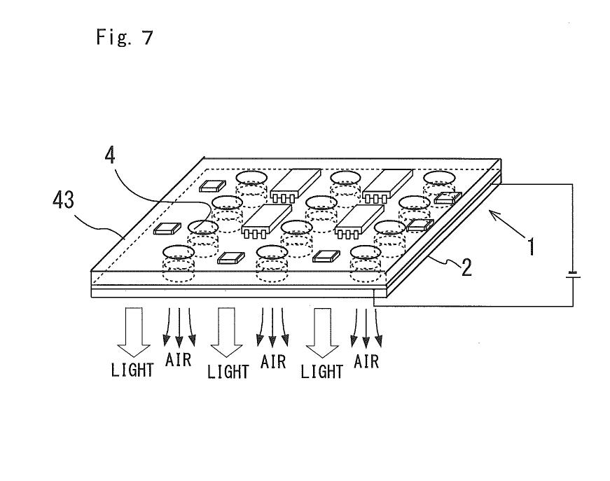

FIG. 7 illustrates a schematic perspective view partially cut showing another illumination panel having ventilating holes of the lighting device according to another embodiment of the present invention. This illumination panel device 1 comprises a control board 43 for the organic EL panel 2 which is provided onto the opposite side of emission surface of the organic EL panel 2. One example of the control board 43 is a control board having a control circuitry for pulse driving the organic EL panel 2 in dimmer control. A housing (not shown) accommodating the internal cavity may be the housing 5 shown in FIG. 1 of the foregoing embodiment communicating from the blower to the conduit, or the housing 5 shown in FIG. 6 including the illumination panel having a fan, so that ventilation is achieved by the holes 4 of the organic EL panel 2.

In this case, holes are formed on the control board 43 so as to be aligned with the holes 4 of the organic EL panel 2. Thus it can be achieved to promote radiation of heat from various electronic parts used in the control circuitry of the organic EL panel 2.

[Illumination Panel Having an Air-Cleaner]

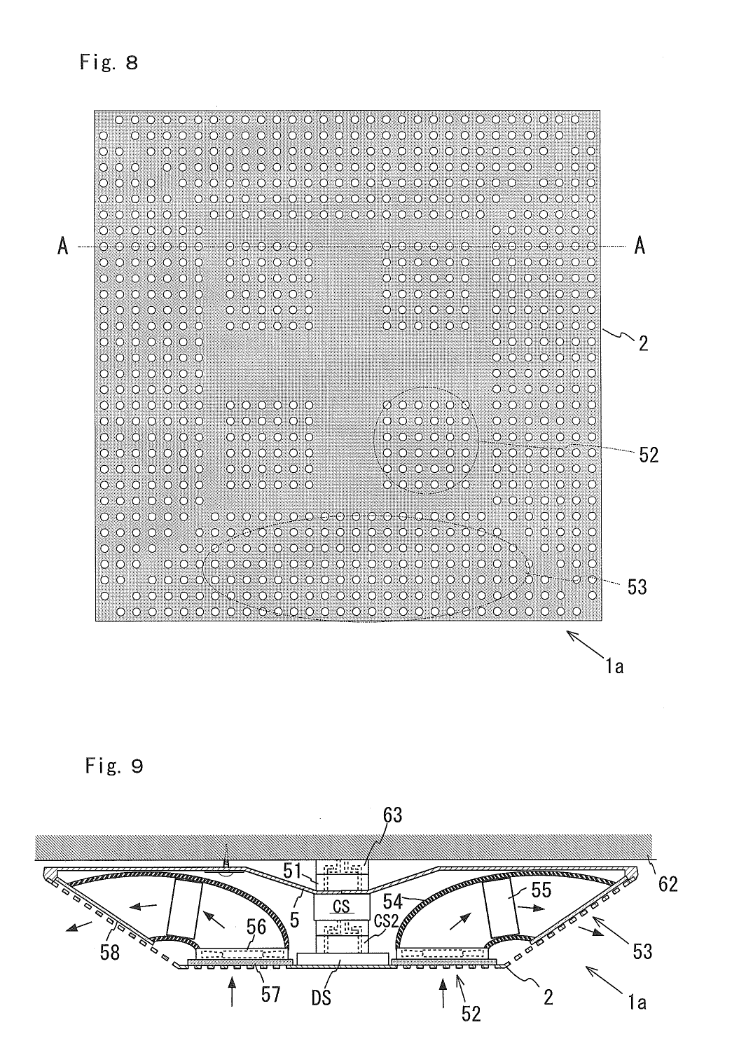

FIG. 8 illustrates a plan view showing another lighting device of an illumination panel with an air-cleaner according to another embodiment of the present invention. FIG. 9 illustrates a cross section view cut along an A-A line in FIG. 8.

As shown in FIG. 9, the lighting device 1a of an illumination panel with an air-cleaner mechanism has a metallic hook 51 (ceiling hook) provided onto the back side of the housing 5 at nearly central portion thereof to receive transmitted electricity. The lighting device is attachable or removable and fixed to the ceiling rosette 63 equipped on a ceiling 62 of a house by the metallic hook 51.

In addition, the housing 5 has an electric connector CS provided at nearly central portion thereof to support and fix the organic EL panel 2 to itself. The organic EL panel 2 has four groups of a plurality of holes 52 as inlet openings provided at the front thereof; and four groups of a plurality of holes 53 as outlet openings provided at the tapered side thereof.

Then, the inlet openings 52 communicate with the outlet openings 53 through a duct 54 partitioned in the housing 5. A dust precipitator 55 is provided halfway in the duct 54. The duct 54 has a blower 56 with a multiple fan or the like provided on the side of the inlet openings 52. Further, the housing 5 has a control unit (not shown) provided inside itself which performs ON/OFF control and status control of both the dust precipitator 55 and the blower 56 while receiving electricity transmitted from the metallic hook 51.

In addition, an inlet air filter 57 is provided along the organic EL panel 2 on the side of the blower 56 facing adjacent inlet openings 52. An outlet air filter 58 is provided along the organic EL panel 2 facing adjacent outlet openings 53.

When the fan of the blower 56 in the housing 5 is rotated, the device sucks indoor air through the inlet openings 52 to the duct 54, and then the inlet air filter 57 adsorbs and removes oily components in the air, after that, the dust precipitator 55 removes smoke components in the air and then deodorizes and cleans up the air, after that, the outlet air filter 58 further filters the air to deodorize it and to eject the air through the outlet openings 53 to indoor space. By such configuration, indoor air is sucked from the front of the housing 5 and ejected to the sides of the housing, so that the device can efficiently purify the air adjacent to the ceiling.

In addition, as shown in FIG. 9, the present embodiment has a drive unit DS which performs the ON/OFF control and status control of the organic EL panel 2 and is provided so as to be integrated with the organic EL panel 2, for example. The drive unit DS of the organic EL panel 2 is connected to a half of the electric connector CS2 (metallic hook) to be connected to the electric connector CS, so that these parts achieve the fixedly locking and the power supply therebetween while the organic EL panel can protect the inlet air filter 57 and the outlet air filter 58.

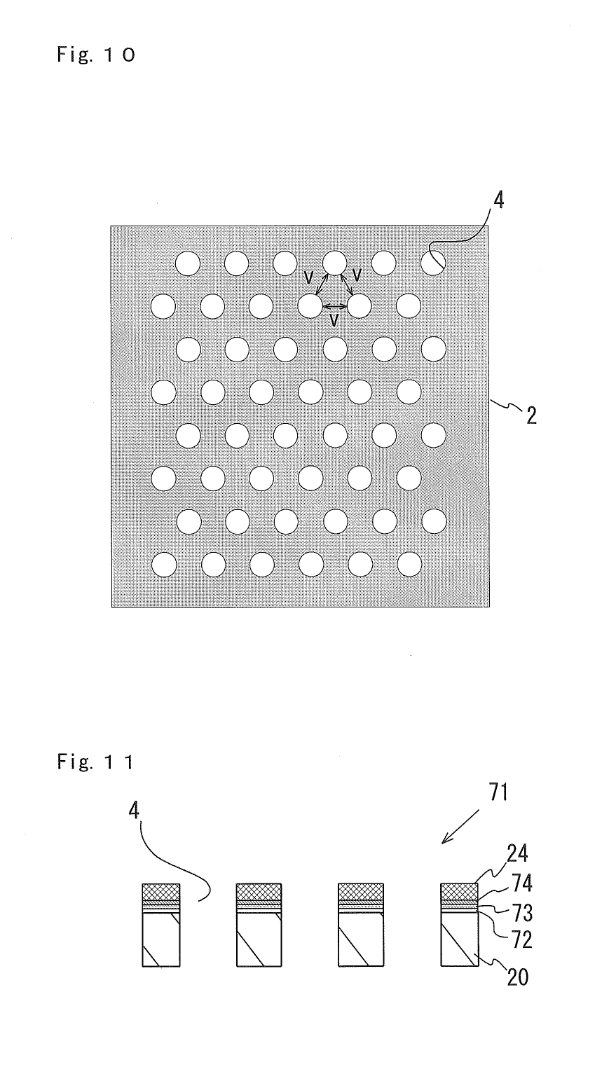

Further, the present embodiment having the organic EL panel 2 as housing with a square bottom in a planar view and a truncated pyramid shape as a whole. The present invention is not limited to the shape. The present invention may include a polygon such as a triangle, rectangle or the like, or a circle, ellipse or the like as a bottom shape in a planar view, or a frustum with a circle or ellipse bottom. That is, the EL panel 2 should have at least two plane faces having different normal lines directing toward different directions respectively, while the holes 4 are formed at both the two plane faces. In addition, as shown in FIG. 10 of a schematic partial plan view showing an organic EL panel 2 of illumination panel having ventilating holes according to another embodiment, a plurality of holes 4 are arranged so that every distance v between respective two adjacent to each other of holes 4 is the same. By the configuration of holes, luminance profile the organic EL panel 2 is homogenized and its intensity is maintained. In addition a shape of each hole is not limited to a circle in the embodiment. The present invention may include an ellipse, rectangle, polygon or the like used for a shape of each hole.

[Lighting Device with an Inorganic EL Panel Used as an Electroluminescence Panel]

In the foregoing lighting device, the organic EL panel is used as an electroluminescence panel. Instead the organic EL panel 2 in the lighting device 1, la of the foregoing embodiments shown in FIG. 1, FIG. 6, FIG. 7 or FIG. 8, an inorganic EL panel may be used as another embodiment. This present embodiment using the inorganic EL panel 71 is shown in FIG. 11 as one exemplary. The inorganic EL panel 71 comprises a transparent substrate 20 of glass or the like; and a first electrode 72 with transparency, a dielectric layer 73, and a second electrode 74 with light-reflectivity which are layered in order on the substrate. The dielectric layer 73 may have a layered structure in which respective light-emitting layers and respective isolation layer are alternatively layered one by one. For the light-emitting layers, there are used sulfides such as SrGa₂S₄:Eu (green), CaS:Eu (red), BaAl₂S₄:Eu (blue) or the like, or oxides. For an isolation layer, there are used oxides such as strontium titanate (SrTiO₃) or the like. Thus each inorganic EL element of the inorganic EL panel is an inorganic EL device comprising a plurality of the inorganic material layer which include the light-emitting layer and layered and disposed between a pair of the first electrode and the second electrode facing each other. The outer surface of the organic EL panel 2 other than the ventilation holes 4 are used for illumination. The inorganic EL panel 71 comprises a protective layer 24 which is provided onto the second electrode 74 in a layered.

According to the present invention, a compact lighting device can be furnished for the illumination of clean room. In addition, since the electroluminescence panel without emission of ultraviolet rays is used in the invention, a yellow filter become useless. Since plural holes are directly provided onto the electroluminescence illumination panel to use the holes for ventilation without any yellow filter, the structure of the lighting device is simplified. Since illumination and ventilation are carried out by the same device of the present embodiment, its efficiency for space utilization is improved. The present embodiment can prolong the emission life of the illuminating device, since the temperature of the electroluminescence panel is lowered by the ventilation. According to the present invention, in addition to the illumination of the clean room, there can be achieved a lighting device which is capable of being unified with an air-conditioner, an air-cleaner or the like.

### EXPLANATION OF REFERENCE NUMERALS

1 Illumination panel device
2 Organic EL panel
4 Hole
5 Housing
6 Conduit
20 Substrate
21 Anode (first electrode)
22 Cathode (second electrode)
51 Metallic hook
52 Inlet opening
53 Outlet opening
54 Duct
55 Dust precipitator
56 Blower
57 Inlet air filter
58 Outlet air filter
62 Ceiling
63 Ceiling rosette
71 Inorganic EL panel
CS2 Half of electric connector
CS Electric connector

1. A lighting device comprising:
a face light emitter; and
a housing having an internal cavity, the internal cavity defined by a wall and the face light emitter;
wherein the face light emitter is an electroluminescence panel,
wherein the electroluminescence panel has a plurality of holes.

2. The lighting device according to claim 1, wherein the electroluminescence panel is an organic electroluminescence panel.

3. The lighting device according to claim 1, wherein the electroluminescence panel is an inorganic electroluminescence panel.

4. The lighting device according to claim 1 comprising an air filter facing the holes in the internal cavity.

5. The lighting device according to claim 1, wherein the two plane faces of the electroluminescence panel have different normal lines, and the holes are arranged at both the two plane faces,
wherein the lighting device comprises a duct communicating the hole at one plane of the two planes and the hole at another plane of the two planes.
